(19) United States
(12) Patent Application Publication
(10) Pub. No.: US 2002/0046195 A1
(43) Pub. Date: Apr. 18, 2002

(54) Method and system for providing stamps by kiosk

(75) Inventors: James D.L. Martin, Royersford, PA (US); J. P. Leon, San Carlos, CA (US); L. Carlton Brown JR., Warrenton, VA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Neopost Inc., Hayward, CA

(21) Appl. No.: 09/902,480

(22) Filed: Jul. 9, 2001

Related U.S. Application Data
(63) Continuation-in-part of application No. 09/708,883, filed on Nov. 7, 2000.
(60) Provisional application No. 60/290,563, filed on May 11, 2001.
(60) Provisional application No. 60/216,779, filed on Jul. 7, 2000.
(60) Provisional application No. 60/216,653, filed on Jul. 7, 2000.
(60) Provisional application No. 60/206,207, filed on May 22, 2000.
(60) Provisional application No. 60/204,357, filed on May 15, 2000.
(60) Provisional application No. 60/181,299, filed on Feb. 9, 2000.
(60) Provisional application No. 60/181,368, filed on Feb. 8, 2000.
(60) Provisional application No. 60/165,885, filed on Nov. 16, 1999.
(60) Provisional application No. 60/164,639, filed on Nov. 10, 1999.

(51) Int. Cl. G06F 17/00

(52) U.S. Cl. 705/401

(57) ABSTRACT

Techniques for dispensing postage from a kiosk using a communications network. A method for obtaining a postage stamp at a kiosk, where the kiosk includes a computer system and a printer, includes, a user inputting into the kiosk a request for the postage stamp. The request is sent to a server via a communications network. The user then receives a markup language response back from the server. Next, the markup language response is processed to obtain an indicium. The indicium includes a digital signature. Lastly, the postage stamp is obtained by printing the indicium by the printer on a label, where the label includes one or more security features.

### BACKGROUND OF THE INVENTION

The present invention relates generally to postage dispensing systems, and more particularly to techniques for dispensing postage from a kiosk using a communication network.

Traditionally, consumers could purchase postage or stamps only from special locations designated by a postal authority. For example, in the U.S., consumers could buy postage only from post offices or other centers specifically authorized by the United States Postal Service (USPS) to sell postage. A disadvantage of this traditional postage buying method is that a consumer has to spend the time and make the effort to physically travel to the post office to buy postage.

In order to alleviate the inconveniences associated with traditional techniques described above, postal authorities such as the USPS, now allow postage to be printed by electromechanical postage meters which can be placed at the consumers' or users' premises. Such postage meters can be leased, rented, or purchased where allowed, from the postal authority or from vendors, such as Neopost Inc., have been authorized by the postal authority to sell the meters. Typically, the user purchases a fixed amount of postage value beforehand and the meter is programmed with this amount. Subsequently, the user is allowed to print postage up to the programmed amount. The meter typically includes a print mechanism and mechanical arrangements and/or electronic control circuitry that direct the operation of the print mechanism.

Because the meter is capable of printing postage having a value, the postal authority generally mandates that, in order to maintain security of the postal funds, the postage meters be acquired and used/handled according to strict, complex, and often bureaucratic regulations imposed by the postal authority. For example, a special meter agreement has to be signed between the meter vendor and the user before the meter can be rented or leased by the user. The user also has to secure a postal license number from a postal authority and the meter has to be seeded with the postal license number. A postal license number is usually associated with a geographical address of a user and is used by the postal authority to track the location of the postage meter and its user. A user using postage meters at multiple geographical addresses has to secure multiple postal licenses, one for each address. Additionally, before a new meter is put into service, the meter has to be inspected and sealed by postal authority personnel. Once in service, each meter has to be periodically inspected by postal authority representatives. Further, postal regulations mandate that the postage meter itself incorporate a variety of security features thereby increasing the costs associated with acquiring and using the meter. As a result, renting or leasing, and subsequently using a postal meter can often be expensive, inconvenient, and involve many bureaucratic hurdles. Consequently, it is quite impractical for individual users to use postage meters.

With a view towards alleviating some of the above-mentioned problems and making use of advances in electronics and communications, the United States Postal Service (USPS) has promulgated specifications for its Information Based Indicia Program (IBIP). The IBIP program supports new methods of applying postage in lieu of conventional approaches that typically rely on the use of a postage meter mechanically printing the indicium on mail pieces.

The IBIP program contemplates postal indicia printed by conventional printers (e.g., thermal, inkjet, or laser) and including human-readable and machine-readable portions. An indicium refers to the imprinted designation or a postage mark used on mail pieces denoting evidence of postage payment. The machine-readable portion was initially specified to be a two-dimensional barcode symbology known as PDF417. The indicium content includes a digital signature for security reasons (to preclude forgery). There are separate specifications for open and closed systems.

An open system is defined as a general purpose computer used for printing information-based indicia, but not dedicated to the printing of those indicia. A closed system is defined as a system whose basic components are dedicated to the production of information-based indicia and related functions, that is, a device dedicated to creating indicia similar to an existing, traditional postage meter. A closed system may be a proprietary device used alone or in conjunction with other closely related, specialized equipment, and includes the indicium print mechanism.

The IBIP program specifies a postal security device (PSD) that manages the secure postage registers and performs the cryptographic operations of creating and verifying digital signatures.

The open system specification describes a host system (a computer or postage meter) connected to an unsecured printer (e.g., a laser printer or the like) and a PSD. The host system also provides communication facilities that allow the PSD's vendor and/or the USPS to establish communications with the PSD. Communications supported include troubleshooting, accounting transactions, and the like.

The PSD and host cooperate to provide an indicium, which is then transmitted to and printed by the unsecured printer. The specified indicium allows the use of an unsecured printer (e.g., thermal, inkjet, or laser) by using a digital signature, which also supports authentication of the mail piece. The indicium includes human-readable information and machine-readable information (initially specified as a PDF417 two-dimensional bar code). Each PSD is a unique security device, having core security functions such as digital signature generation and verification and secure management of information (e.g., descending and ascending registers).

Several techniques have been developed, based on the IBIP program, to streamline and simplify the use of postage meters while providing the required security. For example, U.S. Pat. No. 6,005,945 (Whitehouse) discloses a system for electronic distribution of postage using a secure central computer which generates the postal indicia in response to postage requests submitted by end user computers. However, these conventional techniques, including the system described in the Whitehouse patent, still require the user to apply for and obtain a postal license number from a postal authority. As a result, a user still has to suffer the inconveniences and bureaucratic hurdles of obtaining postal license numbers. Further, since the issuance of postal licenses may take several days or even weeks, valuable time is wasted before a user can make use of services provided by a postage vendor.

In addition, in the Whitehouse patent, the user's request includes the destination address of the mailpiece. The central computer validates this destination address (where alternately, the destination address may have been previously validated) before generating the indicium. The indicium returned to the user includes both the mailpiece origin address and the mailpiece destination address. Thus the stamp has a targeted usage and is missing the convenience of a typical conventional US postage stamp, which is not restricted by origin or destination of the mailpiece. Of course, if the destination is far away, more stamps may be needed, but the restriction is the amount of each stamp not the particular origin and/or destination.

In light of the above, there is a need for techniques which allow a user to buy postage without suffering the inconveniences described above. It is further desirable that the techniques be operable in a distributed environment and make use of communication networks such as the Internet.

### BRIEF SUMMARY OF THE INVENTION

The present invention provides a method, system, and code to obtain postage stamps from an electronic kiosk over a communications network. An embodiment of the present invention provides a method for obtaining a postage stamp at a kiosk, where the kiosk includes a computer system and a printer. The method includes, a user inputting into the kiosk a request for the postage stamp and payment information. The request and the payment information are sent to a server via a communications network. The user then receives a markup language response back from the server. Next, the markup language response is processed to obtain an indicium. The indicium includes a digital signature. Lastly, the postage stamp is obtained by printing the indicium by the printer on a label, where the label includes security features. The markup language includes, for example, one or more of the following: the eXentsible Markup Language (XML), the Hypertext Markup Language (HTML) or the Standard Generalized Markup Language (SGML).

The above method may further include the server receiving a markup language request including the request and the payment information; the server processing the markup language request to obtain the request and the payment information. Next the server validates the payment information and upon validation, generates the indicium based on the request.

Another embodiment of the present invention provides an electronic kiosk for a user obtaining a postage stamp from a central server via a communications network, the electronic kiosk including: a display for receiving a user request for a stamp; a processor operating on software stored in a memory, the software including, an XML processor for reading an XML document including an indicium; a housing having the display, the processor, and the memory; network interface circuitry (NIC) connecting the processor to the communications network, the NIC for receiving the XML document; and a printer coupled to the memory for printing the stamp using the indicium.

An alternative embodiment of the present invention provides a method for obtaining a postage stamp at a kiosk. The kiosk includes a processor, a magnetic card reader, a touch screen display, and a printer. The method includes: the kiosk receiving a request for the postage stamp via the touch screen display and receiving payment information from the magnetic card reader. Next, the kiosk forms an XML request including the request and the payment information. The XML request is sent to a server via a communications network and the server validates the XML request using a request DTD and obtains the request and the payment information. The server then validates the payment information, and upon validation, generates an indicium based on the request, where the indicium includes a digital signature. The server forms an XML response including the indicium, and sends it to the kiosk. The kiosk validates the XML response using a response DTD and obtains the indicium and prints the indicium by the printer on a label, where the label including security features. Optionally, when the printer is printing the indicium on the label, a portion of a video clip is shown on the touch screen display.

These and other embodiments of the present invention are described in more detail in conjunction with the text below and attached figures.

### BRIEF DESCRIPTION OF THE DRAWINGS

FIG. 1 is a simplified block diagram of a distributed computer network which may incorporate an embodiment of the present invention;

FIG. 2 a simplified block diagram of a kiosk of an embodiment of the present invention;

FIG. 3 is a simplified block diagram showing additional details of an exemplary computer system of a kiosk according to an embodiment of the present invention;

FIG. 4 shows an example of four printed stamps on a label sheet of an embodiment of the present invention;

FIG. 5 shows an example of icons and images on a touch screen of an embodiment of the present invention;

FIG. 6 is a flowchart of an initialization routine for the kiosk of an embodiment of the present invention;

FIG. 7 shows a display window on a kiosk flat panel display for purchasing stamps in one embodiment of the present invention;

FIG. 8 shows a display window of a kiosk for selecting different amounts of postage to purchase;

FIG. 9 shows a display window having a moving hand swiping a credit card through a credit card slot in a kiosk;

FIG. 10 is a flow chart showing the process of a user obtaining a stamp from a kiosk of one embodiment of the present invention;

FIG. 11 shows a window for purchase same stamps from a kiosk of a second embodiment of the present invention;

FIG. 12 shows a window having an area for showing a video clip while of the stamps are being printed;

FIG. 13 is a flow chart showing a user obtaining stamps for a second embodiment of the present invention;

FIG. 14 is a simplified high-level flowchart showing processing performed by kiosk and PVS for dispensing postage according to an embodiment of the present invention;

FIG. 15 depicts an expanded block diagram of PVS according to an embodiment of the present invention;

FIG. 16 is a simplified flow chart showing the processing by the PVS of an indicium request; and

FIG. 17 is a flowchart expanding on the check request validity of FIG. 16 of an embodiment of the present invention.

### DESCRIPTION OF THE SPECIFIC EMBODIMENTS

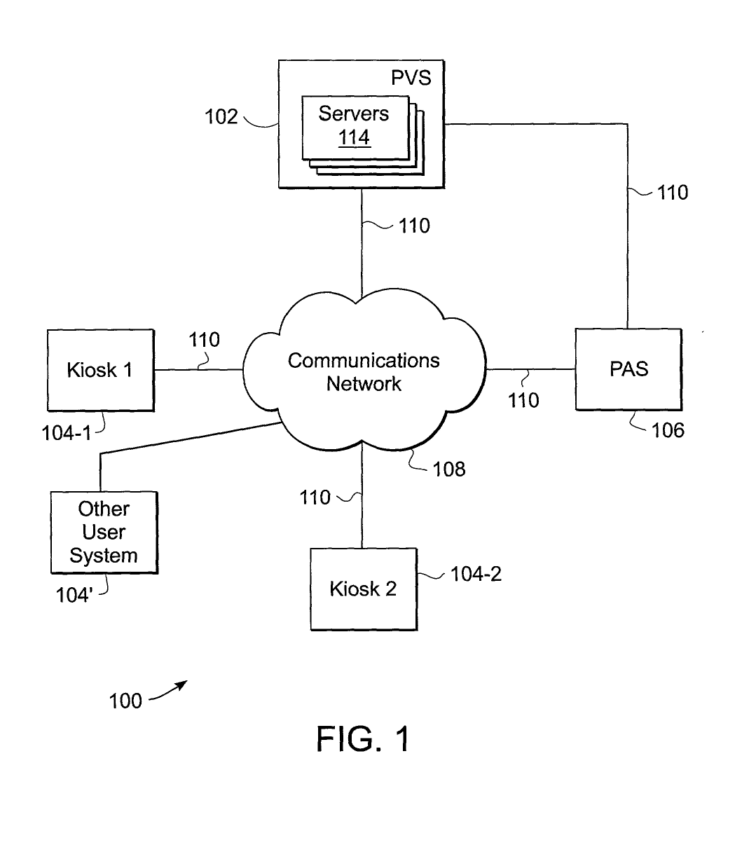

FIG. 1 is a simplified block diagram of a distributed computer network 100 that may incorporate an embodiment of the present invention. Computer network 100 includes one or more kiosk systems 104-1 and 104-2 (herein a kiosk system is referred to either as a “kiosk system” or just as a “kiosk”), at least one postage vendor system (PVS) 102, and a postal authority system (PAS) 106 coupled to a communications network 108 via a plurality of communication links 110.

Communications network 108 provides a mechanism for allowing the various components of distributed network 100 to communicate and exchange information with each other. Communications network 108 may itself comprise many interconnected computer systems and communication links. Communication links may be hardwire links, optical links, satellite or other wireless communication links, wave propagation links, or any other mechanisms for communication of information. While in one embodiment communications network 108 is the Internet, in other embodiments, communications network 108 may be any suitable computer network. Distributed computer network 100 depicted in FIG. 1 is merely illustrative of an embodiment incorporating the present invention and does not limit the scope of the invention as recited in the claims. One skilled in the art would recognize other variations, modifications, and alternatives. For example, more than one PVS 102 may be coupled to communications network 108.

Kiosks 104 allow users of the present invention, for example, postage consumers, to interact with and buy postage from PVS 102. Various different types of interactions with PVS 102 are facilitated by kiosks 104. For example, users may use kiosks 104 to configure requests to purchase postage from PVS 102. These user purchase requests are then communicated from kiosks 104 to PVS 102 via communications network 108. In response to the user requests, kiosk 104 may receive information for printing indicia (or a single indicium) from PVS 102. A user may then use kiosk 104 to print the indicia using a printer device, where the printer device is part of the kiosk 104. The indicia may be printed on labels (which may have security features embedded as illustrated in U.S. patent application Ser. No. 09/708,971, entitled “Providing Stamps on Secure Paper Using a Communications Network,” by J. P. Leon, et. al., filed Nov. 7, 2000, which is herein incorporated by reference), on paper, on the mail pieces themselves, or on other like media. In alternative embodiments of the present invention, a user using kiosk 104 may store the information for printing indicia received from PVS 102 on a storage medium, such as a computer disk, for subsequent printing of the indicia.

Users may also use kiosks 104 to perform other activities such as browse web-pages stored by PVS 102, register as users of services provided by PVS 102, provide financial and credit information for consummating commercial transactions with PVS 102, review status of user accounts maintained by PVS 102, review postage purchase history, access help or customer services provided by PVS 102, and to perform other like activities. Accordingly, in a client-server environment, kiosk 104 typically operates as a client requesting information from PVS 102, which operates as a server that performs processing in response to the client request and provides the requested information to the client systems. It should be however apparent that a particular kiosk 104 may act both as a client and a server depending on whether the kiosk is requesting or providing information. In an alternative embodiment, kiosk 104 may be operated as a stand-alone device, which is connected to a communications network at a different time and optionally, a different location, to exchange information with the PVS 102.

As stated above, a user may use kiosk 104 to browse or interact with web pages provided by PVS 102. These web pages may be stored by one or more web servers of PVS 102 and may be accessed by users of kiosk 104 via a browser program executing on kiosk 104. Examples of browser programs include the Internet Explorer browser program provided by Microsoft Corporation, the Netscape Navigator browser provided by Netscape Corporation, and others. In the Internet and World Wide Web (the “Web”) environment, the web pages may be written in Hypertext Markup Language (HTML) and may incorporate any combination of text, graphics, audio and video content, software programs, and other data. Web pages may also contain hypertext links to other web pages. Each web page is uniquely identified by an address called a Uniform Resource Locator (URL) that enables users to access the web page. Users may access web pages by providing URL information to the browser, either directly or indirectly, and in response, a web page corresponding to the user-specified URL is downloaded from a server coupled to communications network 108 to the requesting kiosk 104. The downloaded web page may then be viewed by the user using the browser.

According to the aspects of the present invention, PVS 102 is responsible for dispensing postage in response to postage purchase requests received from kiosks 104. As shown in FIG. 1, PVS 102 may itself comprise multiple interconnected computer and server systems 114 and communication links, as will be described below. PVS 102 may be configured to receive postage requests from kiosks 104, validate the postage requests, generate information for printing indicia in response to the postage requests, perform security functions related to the postage transactions, manage funds related to the postage transactions, communicate the information for printing the indicia to the requesting kiosks 104, maintain and manage user accounts, and several other functions. These functions are generally performed by software code modules executed by PVS 102. However, it should be apparent that these functions may be also performed by software modules or hardware modules of PVS 102, or combinations thereof.

According to an embodiment of the present invention, the information for printing indicia generated by PVS 102 is generally along the lines specified by the IBIP specifications published by the United States Postal Service (USPS). According to aspects of the present invention, the security-critical functions performed by PVS 102 as part of generating the information for printing the indicia comply with the security-critical functions performed by the Postal Security Device (PSD) described in the IBIP specifications. PVS 102 may also be configured to perform functions performed by the Host System described in the IBIP specifications.

Referring back to FIG. 1, postal authority system (PAS) 106 may comprise one or more computer systems managed by a postal authority authorized to regulate and control postal matters. Examples of postal authorities include the United States Postal Service (USPS), France's La Poste, the United Kingdom's Royal Mail, and others. In most instances, the postal authority is a governmental or quasi-governmental agency authorized to oversee postal matters. PAS 106 may be coupled to PVS 102 via communications network 108 or directly via some other communication link 110. The information exchanged between PVS 102 and PAS 106 may include finance information, information required by the postal authority for audit purposes, status information, security information, and other like information. The information required by the postal authority for audit purposes may include information identifying the postage buyers, the postage value and amount purchased by the buyers, and other information. PVS 102 may be configured to download information to PAS 106 on a periodic basis using batch processing, or upon the occurrence of certain events. PVS 102 may also be configured to purchase postage from PAS 106.

In one preferred embodiment, a kiosk 104 is a single housing that includes a computer, a display, and input device, and a printer. The computer includes a processor, memory, and a network connection. The network connection is for connection to a PVS 102 via a communications network, for example, the Internet. The display and input device are combined in a touch screen flat panel display. In an alternative embodiment the display may be a LCD or CRT display with a separate keypad included as part of the single housing. There is one printer dedicated to printing postage stamps on labels having security features, such as a watermark, microprint, a fluorescent stripe, and others as shown in U.S. patent application Ser. No. 09/708,971.

The kiosk is typically located in a place readily accessible to the public, for example, a store, supermarket, gas station, restaurant, a post office, on the side of a building, a bank, government building, airport, bus station, subway station, train station, apartment complex, resort, hotel, motel, and so forth. The kiosk neither accepts nor dispenses cash, but uses an electronic form of payment using, for example, a credit card, club card, ATM card, or smart card. And while one of the primary purposes of the kiosk of the preferred embodiment is to dispense postage stamps, other uses, such as electronic commerce, sending/reading email, banking, buying tickets, paying bills, searching the Internet, video teleconferencing, viewing advertisements, movie clips, or just browsing the Web, may be done by the user.

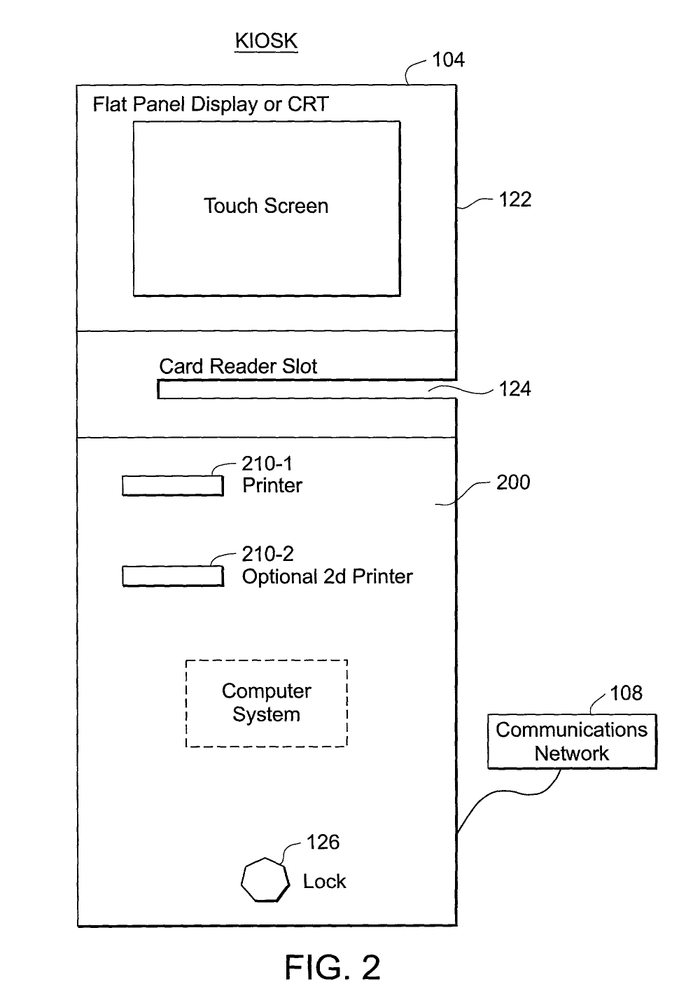

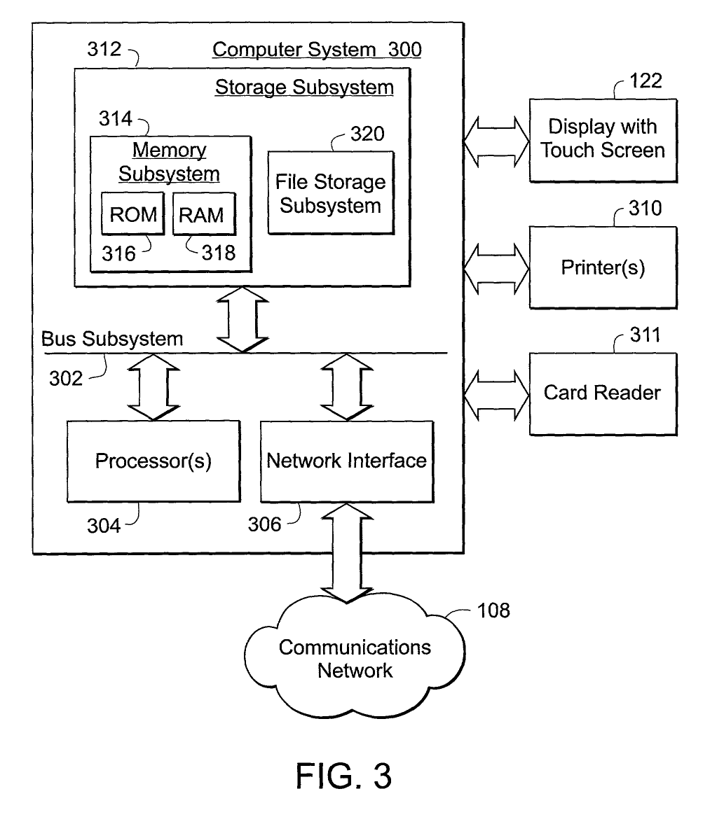

FIG. 2 a simplified block diagram of a kiosk 104 of an embodiment of the present invention. The kiosk components are preferably located within one secure housing with, for example, a lock 126. Kiosk 104 includes a touch screen 122, a card reader slot 124, a computer system 300 located in an area 200, a printer outlet 210-1 and a second optional second printer outlet 210-2. The labels or, for example, any printed item with an associated monetary value, such as a ticket, are sent by printer(s) 210 in FIG. 3 through printer outlets 210-1 and 210-2. Card reader slot 124 is to read, for example, a credit card, smart card, bank card, or ATM card. Kiosk 104 is connected to the communications network 108.

FIG. 3 is a simplified block diagram showing additional details of an exemplary computer system 300 of kiosk 104 according to an embodiment of the present invention. Computer system 300 typically includes at least one processor 304, which communicates with a number of internal devices via a bus subsystem 302. These internal devices typically include a storage subsystem 312, comprising a memory subsystem 314 and a file storage subsystem 320, and a network interface subsystem 306. Computer system 300 is connected to several peripheral devices, for example, one or more printers 310 located behind printer slot(s) 210, a card reader 311 coupled to card reader slot 124, and touch screen 122. The input and output devices allow user interaction with computer system 300. A network interface subsystem 306 provides an interface to outside networks, including an interface to communications network 108, for example, the Internet. The network interface circuitry may be disposed on a separate card or may share a circuit board with other systems components.

Storage subsystem 312 stores the basic programming and data constructs that provide the functionality of the kiosk. Examples of kiosk software are given in the computer program listing appendix, which is incorporated by reference in its entirety. These software modules are generally executed by processor(s) 304. Storage subsystem 312 may optionally provide a repository for storing the various databases that maintain information regarding kiosk transactions. Storage subsystem 312 typically comprises a memory subsystem 314 and a file storage subsystem 320.

Memory subsystem 314 typically includes a number of memories including a main random access memory (RAM) 318 for storage of instructions and data during program execution and a read only memory (ROM) 316 in which fixed instructions are stored. File storage subsystem 320 provides persistent (non-volatile) storage for program and data files, and may include a hard disk drive, a floppy disk drive along with associated removable media, a Compact Digital Read Only Memory (CD-ROM) drive, an optical drive, removable media cartridges, and other like storage media. One or more of the drives may be located at remote locations on other connected computers at another site on communications network 108. Information stored according to aspects of the present invention may also be stored by file storage subsystem 320.

Bus subsystem 302 provides a mechanism for letting the various components and subsystems of computer system 300 communicate with each other as intended. The various subsystems and components of computer system 300 need not be at the same physical location but may be distributed at various locations within distributed communications network 108. Although the bus subsystem 302 is shown schematically as a single bus, alternative embodiments of the bus subsystem may utilize multiple busses.

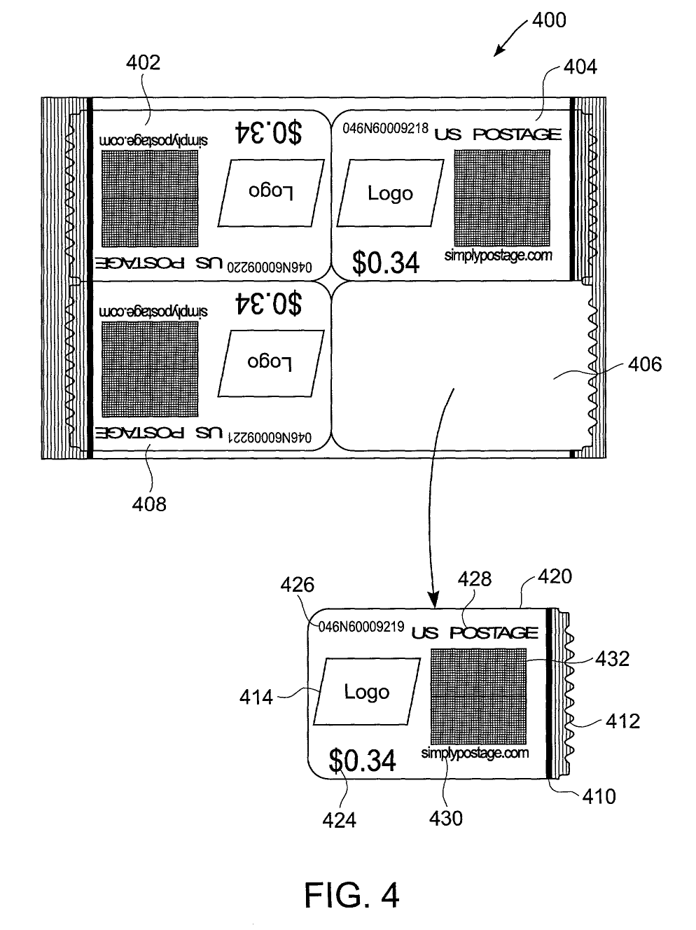

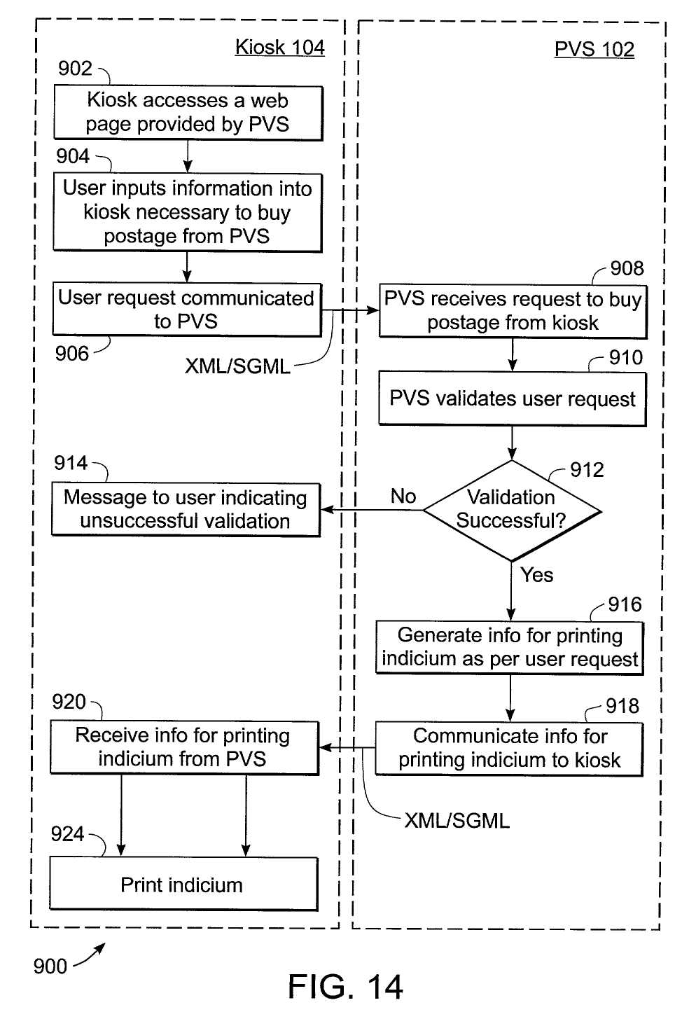

FIG. 4 shows an example of four printed stamps on a label sheet 400 of an embodiment of the present invention. Label sheet 400 shows stamps 402, 404, 406, and 420, where stamp 420 has been removed from location 406. Stamp 420 includes a microprint strip 410, a fluorescence strip 412 having serrated edges, a logo 414, e.g., the U.S. Post Office Eagle, the postage amount “$0.34” 424, the meter serial No., “046N0009219” 426, the text “U.S. POSTAGE” 428, a data matrix 432, which includes a digital signature, and a company Web address 430, for example, “simplypostage.com”. Stamp 420 is printed on a label that initially includes microprint strip 410, the fluorescent strip 412 and logo 414. The same is also holds for the three other labels before a stamp is printed on them in label sheet 400 above. The label sheet is stored in the kiosk area 200 which has printer 310 coupled with printer slot 210-1. The label sheet has initially four preprinted labels, each with microprint 410, fluorescence strip 412, and logo 414. As seen below in FIG. 14, after the XML request for postage is sent from the kiosk to the PVS and the PVS sends an XML response having the four indicia, the printer 210 prints the four stamps on the label sheet 400 and outputs the printed stamps to the user via printer slot 210-1.

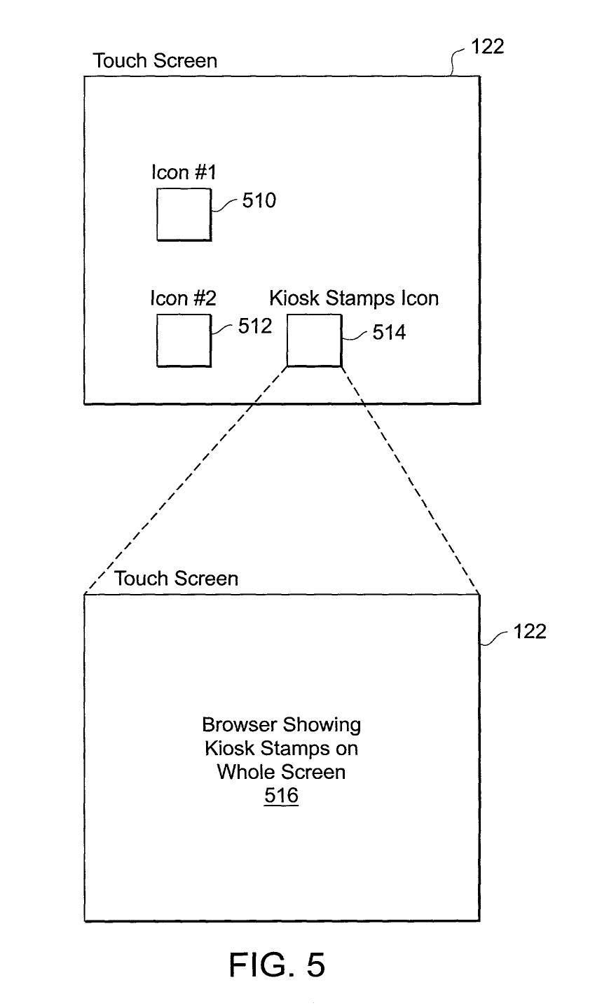

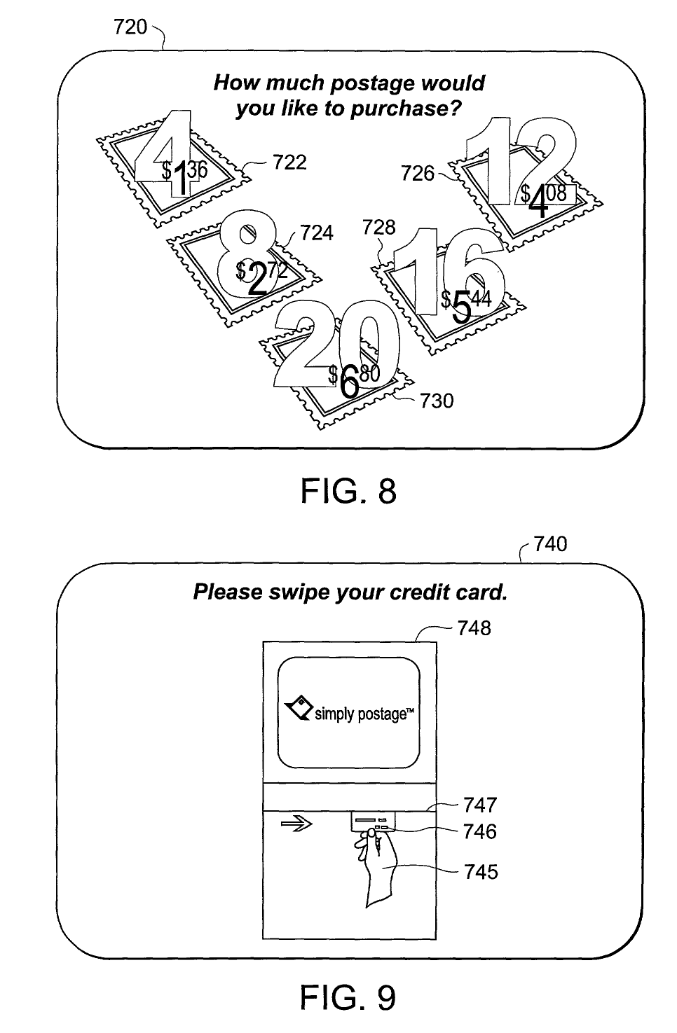

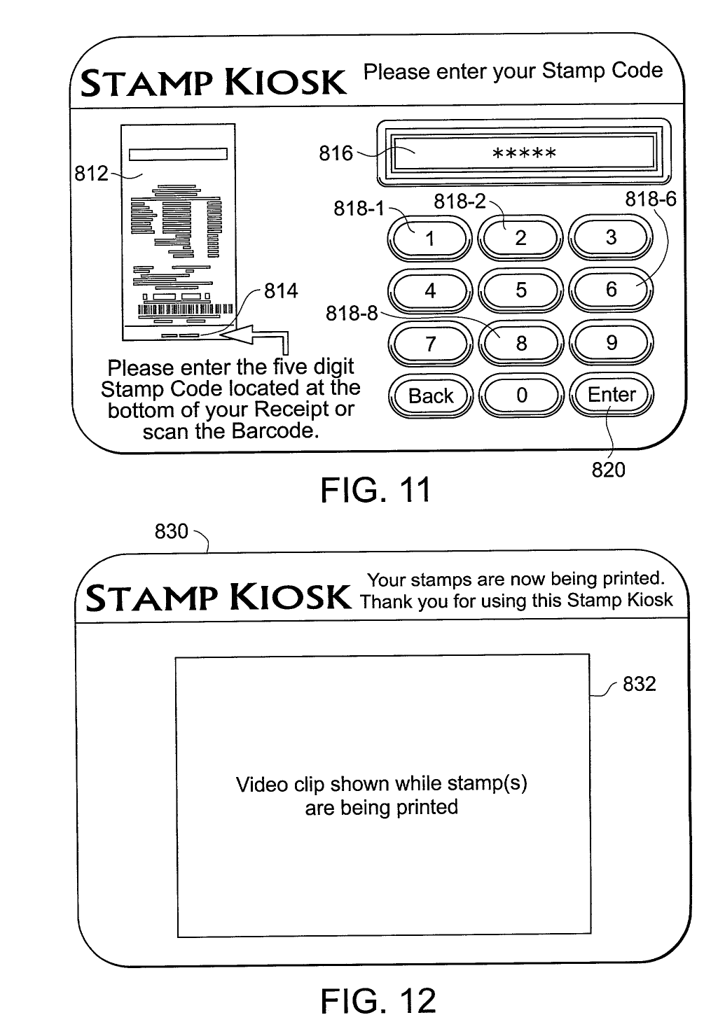

FIG. 5 shows an example of icons and images on touch screen 122 of an embodiment of the present invention. Touch screen 122 shows three icons 510, 512, and a kiosk stamp icon 514. Kiosk stamp icon 514, when selected, expands to show a browser window 516 filing the entire touch screen 122-2. In alternative embodiments when kiosk stamp icon 514 is selected the browser window 516 fills only a part of the whole touch screen. The browser window 516 may show, for example, window 710 in FIG. 7, window 720 in FIG. 8, window 740 in FIG. 9, window 810 in FIG. 11, and window 830 in FIG. 12.

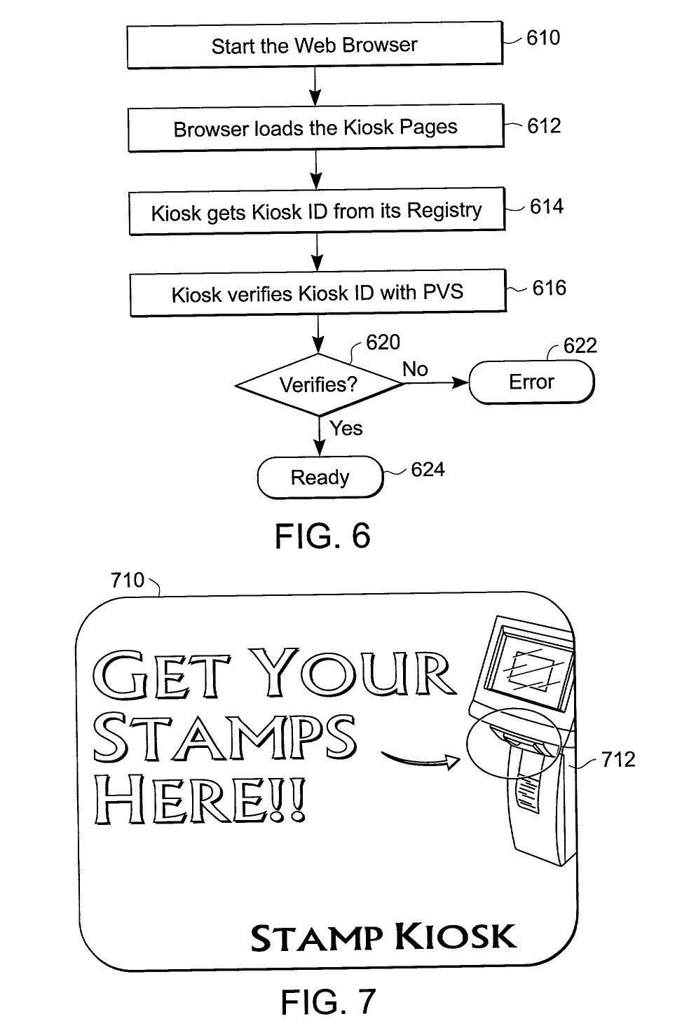

FIG. 6 is a flowchart of an initialization routine for the kiosk 104 of an embodiment of the present invention. At a step 610 the Internet browser is started. For example kiosk stamp icon 514 is selected and expanded either automatically or manually as in FIG. 5. At a step 612 the browser loads the kiosk web pages from the web server at the PVS 102. At a step 614 the kiosk processor 304 gets the kiosk ID from the Windows Registry stored in the storage subsystem 312. The kiosk then verifies this kiosk ID with the PVS 102. If the verification fails then the kiosk reports an error (step 622). If the kiosk ID is verified, the kiosk is ready to process a request for stamps (step 624). In another embodiment the Media Access Control (MAC) address of the kiosk's network interface circuitry (NIC) 306 is used as the kiosk ID, and the PVS maintains a listing of the valid NIC MAC addresses.

FIG. 7 shows a display window 710 on a kiosk display for purchasing stamps in one embodiment of the present invention. The display window 710 includes an image of a kiosk 712.

FIG. 8 shows a display window 720 of a kiosk for selecting different amounts of postage to purchase. There are five selections shown, where each selection has a different number of stamps. There are four stamps 722, 8 stamps 724, 12 stamps 726, 16 stamps 728, and 20 stamps 730, that a user may select for purchase.

FIG. 9 shows a display window 740 having a moving hand 745 swiping a credit card 746 through a credit card slot 747 in a kiosk 748. The movement of the hand is accomplished via MPEG images or a video clip.

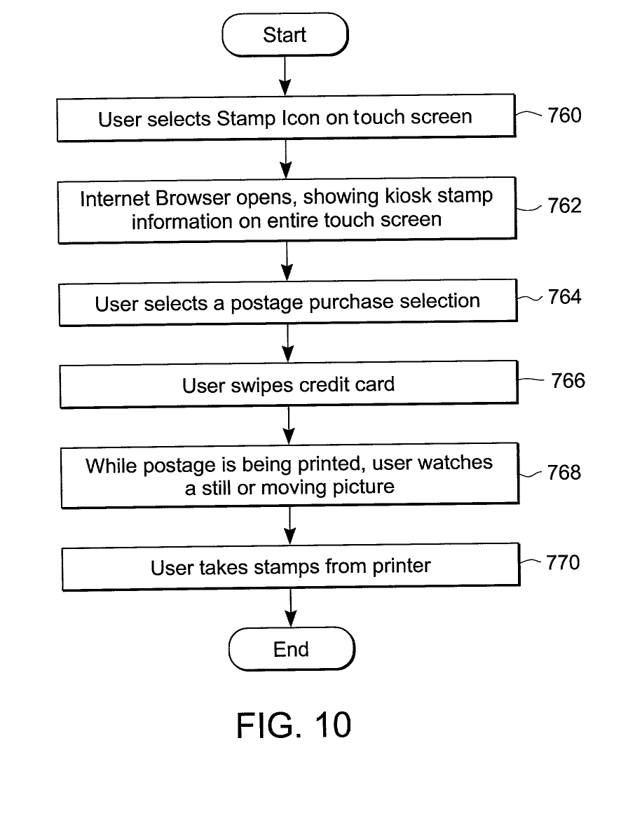

FIG. 10 is a flowchart showing the process of a user obtaining a stamp from a kiosk of one embodiment of the present invention. At a step 760 the user selects the kiosk stamp icon 514 on touch screen 122. The Internet browser opens showing the kiosk stamp information, for example display window 710 of the FIG. 7, on the entire touch screen (step 762). At a step 764 the user makes a postage purchase selection by selecting one of the five numbers of stamps 722, 724, 726, 728 or 730 in window 720 of FIG. 8. At a step 766 the user swipes a credit card through the card reader slot 124. While the postage is being printed, the user may watch a still or a moving picture (step 768). At step a 770 the user takes the stamps, for example, the printed label sheet 400 in FIG. 4, from the printer slot 210-1.

FIG. 11 shows display window 810 for purchase same stamps from a kiosk of a second embodiment of the present invention. Display window 810 includes an image of a receipt 812 which has a five digit stamp code 814 located at the bottom of receipt 812, an input area 816 to enter the five-digit code, and an image of a keypad, for example, numeric keys 818-1, 818-2, 818-6, 818-8, and enter key 820. In one embodiment enter key 820 is not visible until the five digits have been entered in input area 816. At that time, pressing enter key 820 causes validation of the five-digit stamp code. In other embodiments, there may be more or fewer than five digits, and/or the enter key may always be visible.

FIG. 12 illustrates a display window 830 having an area 832 for showing a video clip or MPEG images or streaming video or graphic images or animation, while the stamps are being printed. This allows the user to be informed or entertained while waiting for the kiosk to process and print the selected stamps.

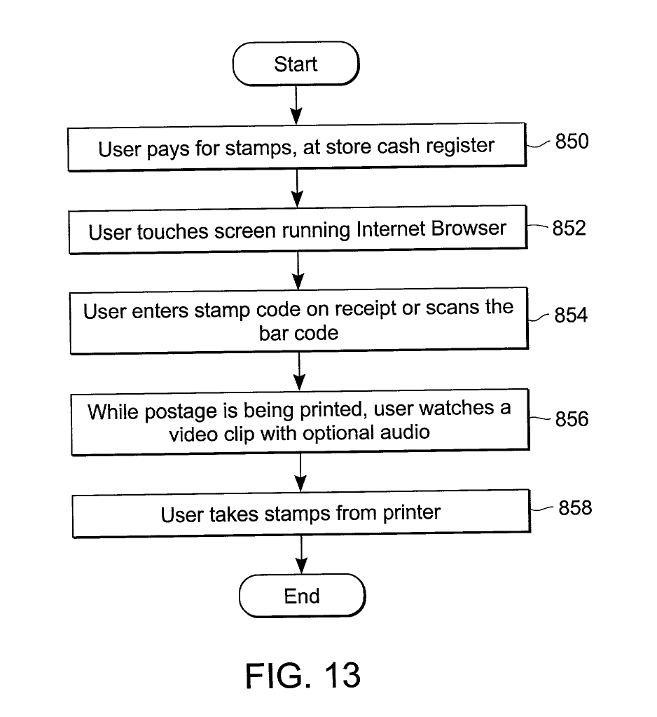

FIG. 13 is a flow chart showing a user obtaining stamps in a second embodiment of the present invention. At a step 850 the user pays for the stamps at the store cash register. The user then activates the Internet browser on the kiosk touch screen at a step 852. At a step 854 the user either enters the stamp code on the receipt using, for example, field 816 in FIG. 11 or the user scans the bar code (not shown). At step 856 while the postage is being printed, the user watches a video clip with optional audio as shown in FIG. 12. At a step 858 the user takes the stamps from the printer slot 210-1.

FIG. 14 is a simplified high-level flowchart 900 showing processing performed by kiosk 104 and PVS 102 for dispensing postage according to an embodiment of the present invention. As shown in FIG. 14, processing is generally initiated when a user accesses a web page provided by PVS 102 using kiosk 104 (step 902). As described above, the user may access the web pages by providing URL information corresponding to the web pages to a browser executing on kiosk 104. Using the web page(s), the user may then configure a request to buy postage from PVS 102 (step 904). For example, the user may request purchase of one or more $0.34 stamps. The user request to purchase postage may include information identifying the user, credit-card, ATM, bank account, club card, smart card, or other like information which will be used by PVS 102 to bill for the purchased postage, the amount and value/denomination of the postage which the user wishes to purchase, and other like information which may be used by PVS 102 to process the request. In an alternative embodiment the user may pay for the stamps at a checkout counter in a store and get a code number to be entered into the kiosk's touch screen. A user may request purchase of one or more stamps.

Kiosk 104 then communicates the user's request to purchase postage to PVS 102 via communications network 108 (step 906). According to an embodiment, a secure socket layer (SSL) connection may be established between kiosk 104 and PVS 102 to facilitate communication of information between user system 104 and PVS 102. The postage request is sent using the eXenstible Markup Language (XML). In an alternative embodiment the Standard Generalized Markup Language (SGML) may be used instead of XML. SGML is a language for describing languages, i.e., a meta-language. XML is a subset of SGML. In another embodiment HTML is used. Yet another embodiment uses a markup language in which the logical structure has customizable constraints. Other embodiments use a combination of one or more of HTML, SGML, or XML.

Each XML document has both a logical and a physical structure. Physically, the document is composed of storage units called entities. An entity may be nested in another entity. Logically, the document includes declarations, elements, comments, character references, and processing instructions, all of which are indicated in the document by explicit markup. XML provides a mechanism, the document type declaration (DTD), to define constraints on the logical structure and to support the use of entities. The DTD contains or points to markup declarations, i.e., element type declarations, that provide a grammar for a class of documents. A software module called an XML processor is used to read XML documents and provide access to their content and structure.

PVS 102 then receives the user request to purchase postage from kiosk 104 (step 908). PVS 102 may then validate the user request (step 910). For example, PVS 102 may determine if the credit-card information provided by the user is valid. PVS 102 may use services provided by companies such as Cybercash and Cybersource to perform the credit-card information validation. If the request is from a registered user who has a pre-funded account, PVS 102 may determine if the user has sufficient finds in the user's account maintained by PVS 102 to satisfy the postage request. Alternatively, PVS 102 may determine if the credit-card information for the registered user is stored by PVS 102 or provided to PVS 102 by the user request. PVS 102 may also validate other information such as the identity of the user requesting the purchase, the type of postage requested by the user, and the like. If the validation process fails for any reason (step 912), the user's request may be terminated and a message may be communicated to the requesting kiosk 104 indicating that validation of the user request was not successful (step 914). A reason why the validation failed may also be provided.

If validation is successful, PVS 102 then generates information for printing an indicium for each stamp requested in the user postage request (step 916). According to an embodiment of the present invention, the information for printing the indicium generated by PVS 102 is along the lines specified in the IBIP specifications published by the USPS. For each indicium, the information for printing the indicium may include a bitmap of the indicium, a graphical image of the indicium, data representing the indicium, raw data corresponding to the indicium, or other information which facilitates printing of the indicium. The information for printing the indicium in a markup language format, e.g., an XML format, is then communicated from PVS 102 to the requesting the kiosk via communications network 108 (step 918). In an alternative embodiment SGML may be used instead of XML. In another embodiment HTML is used. Yet another embodiment uses a markup language format in which the logical structure has customizable constraints. Other embodiments use a combination of one or more of HTML, SGML, or XML.

The requesting kiosk 104 then receives the information for printing the indicium (or indicia) from PVS 102 (step 920). The information received in step 920 may then be used to print the indicium (step 924). A printer device as part of the kiosk is used to print the indicium (or indicia). According to an embodiment of the present invention, user system 104 may process the information received from PVS 102 before printing the indicium according to step 924. The indicium may be printed on any suitable medium such as a label, paper, sheet of labels, envelopes, cards, directly on the mail piece/package, or other like media. One or more indicia may be printed at a time. In alternative embodiments of the present invention, the user may store the information for printing the indicia on a storage medium, such as a memory disk, for subsequent printing.

In order to reduce fraudulent imprinting of the indicium, the medium on which the indicium is printed may be configured to possess special features which provide enhanced security against fraudulent misuse. For example, the indicium may be printed on labels which may contain any or all of a variety of security features, such as bar-coding, micro-printing, watermarking, use of fluorescent strips, serrated edges, taggants, and the like. The indicium or indicia may then be printed on one or more labels which may then be affixed onto the mail piece/package (just like an ordinary stamp purchased from the post office).

For an embodiment of the present invention, an example of some of the code used in printing the indicium (or indicia) according to step 924 is given in the computer program listing appendix. The printer program may include, for example, OCX, a Java applet, a VBScript, a Java Script, ActiveX controls, a C++ program, a C program, a Java program, etc.

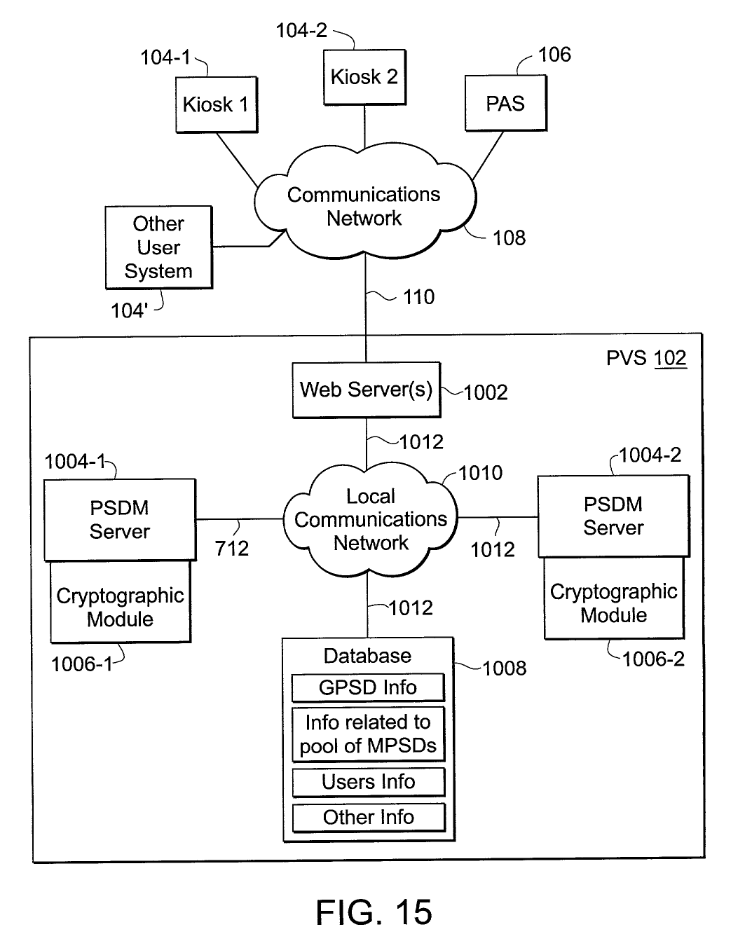

FIG. 15 is an expanded block diagram of PVS 102 according to an embodiment of the present invention. As shown in FIG. 15, PVS 102 may comprise one or more web servers 1002, one or more postal security device module (PSDM) servers 1004 (with associated cryptographic modules 1006), and a database 1008 coupled to a local communications network 1010 via a plurality of communication links 1012. Local communications network 1010 provides a mechanism for allowing the various components of PVS 102 to communicate and exchange information with each other. Local communications network 1010 may itself be comprised of many interconnected computer systems and communication links. Communication links 1012 may be hardwire links, optical links, satellite or other wireless communication links, wave propagation links, or any other mechanisms for communication of information. The configuration of PVS 102 depicted in FIG. 15 is merely illustrative of an embodiment incorporating the present invention and does not limit the scope of the invention as recited in the claims. One skilled in the art would recognize other variations, modifications, and alternatives.

Web server(s) 1002 may host the postage vendor's web site and store web pages provided by the postage vendor. Web server 1002 is responsible for receiving URL requests from user systems 104 and for forwarding web pages corresponding to the URL requests to the requesting user systems 104. As previously stated, these web pages allow a user to interact with PVS 102. e.g. to configure a request to purchase postage from PVS 102. When user system 104 requests communication with PVS 102, the web server may be configured to establish a communication link between kiosk 104 and PVS 102. For example, web server 1002 may establish a secure Internet socket link. e.g. a SSL 2.0 link, between PVS 102 and kiosk 104. The information communicated between user system 104 and PVS 102 may be SSL encrypted using various encryption levels, e.g. 40-bit encryption, 128-bit encryption, and the like. Web server 1002 may also incorporate a firewall which shields the internal PVS network from communications network 108 and kiosks 104 and other resources coupled to communications network 108. According to an embodiment of the present invention, web server 1002 is responsible for receiving requests from kiosks 104 to purchase stamps and for performing load distribution and fail-over processing associated with the requests. Web server 1002 may also be configured to control the downloading of printer control programs from PVS 102 to kiosk 104.

Each PSDM server 1004, in conjunction with one or more cryptographic modules 1006 coupled to the PSDM server, is responsible for generating the indicium or indicia. According to an embodiment of the present invention, functions performed by PSDM server 1004 include functions performed by a postal security device (PSD) as described in the IBIP specifications published by the USPS. For example, functions performed by PSDM server 1004 include initialization and creation of PSD resources, digital signature generation, management of funds related to the postage dispensed by PVS 102, generation of information for printing the indicia, key handling, and other functions. PSDM servers 1004 are designed to operate in a clustered environment to allow for expandability to meet the needs of a rapidly growing user base. According to an embodiment of the present invention, PSDM server 1004 communicates with web server 1002 using a DCOM (Microsoft's Distributed Component Object Model) interface.

Each PSDM server 1004 may comprise one or more cryptographic modules 1006 for performing cryptographic functions and for generating digital signatures. Various keys for performing security-critical functions such as digital signature generation, hashing, encryption, etc. are stored by cryptographic module 1006. According to an embodiment of the present invention, cryptographic module 1006 is an nCipher nFast/CA module which is validated to FIPS 140-1 Level 3 security.

According to aspects of the present invention, PSDM server 1004 uses PSD resources to generate information for printing indicia and to track monetary amounts related to the postage dispensed by PVS 102. In order to increase the indicia generation throughput, a plurality of shared PSD resources may be used by PSDM servers 1004 to generate the indicia. By using a plurality of PSD resources, multiple PSDM servers 1004 can run concurrently, producing indicia in parallel without the bottleneck of sharing a single PSD resource.

According to an embodiment of the present invention, each PSD resource comprises a unique PSD identifier (e.g. a 4-byte identifier), a descending register (DR) value (e.g. a four-byte value), an ascending register (AR) value (e.g. a five-byte value), and a control code (e.g. a 20-byte value). The PSD identifier uniquely identifies each PSD resource. The ascending register (AR) value represents the total monetary value of all indicia ever produced by the PSD during its life cycle. The descending register (DR) value indicates the available finds assigned to the PSD resource which may be used to dispense postage. According to an embodiment of the present invention, the monetary values stored by the AR and DR values are measured in 1/10 of 1-cent increments as specified in the IBIP specifications. The control code is a secure hash of the PSD identifier, the PSD AR value, and the PSD DR value. According to an embodiment of the present invention, the control code is generated using HMAC-with-SHA1 (RFC 2104) using a secret HMAC key stored by cryptographic module 1006.

In a specific embodiment of PVS 102, monetary amounts related to the postage dispensed by PVS 102 are tracked using a global PSD (GPSD) resource and a pool of PSD resources referred to as mini-PSDs (or MPSDs) stored by PVS 102. According to an embodiment, eight MPSD resources may be used by a single cryptographic module 1006 associated with PSDM server 1004 to concurrently generate information for printing indicia. The sum of the AR value and the DR value of the GPSD resource represents the total amount of postage bought from the postal authority, for example, from the USPS, by the postage vendor provider (e.g. Neopost Inc.) of PVS 102. The sum totals of the AR and DR values of the MPSD resources matches the AR and DR values of the GPSD resource. Information related to the GPSD resource and MPSD resources may be stored in database 1008.

According to an embodiment of the present invention, each MPSD resource may be assigned a unique number by the postage vendor. A number assigned to a particular MPSD may be included in the information for printing an indicium generated by the particular MPSD and printed as part of the indicium. For example, the number “046N60009219” (reference 426 in FIG. 4) uniquely identifies the MPSD resource which was used for generating the information for printing the indicium depicted in FIG. 4. This MPSD serial number is like a meter number and may be used to track the MPSD resource responsible for generating information for printing the indicium.

Database 1008 acts as a repository for storing information related to the postage dispensing process. For example, database 1008 may store information related to the PSD resources (both GPSD and MPSDs), information used for generation of digital signatures, and other like information. Database 1008 may also store the postal license number assigned to PVS 102 by the postal authority. Other information related to the dispensing of postage may also be stored by database 1008. The term “database” as used in this application may refer to a single database or to a plurality of databases coupled to local communications network 1010. Further, database 1008 may be a relational database, an object-oriented database, a flat file, or any other way of storing information. According to an embodiment, database 1008 is coupled to web server 1002 and to PSDM server 1004 via an ODBC interface.

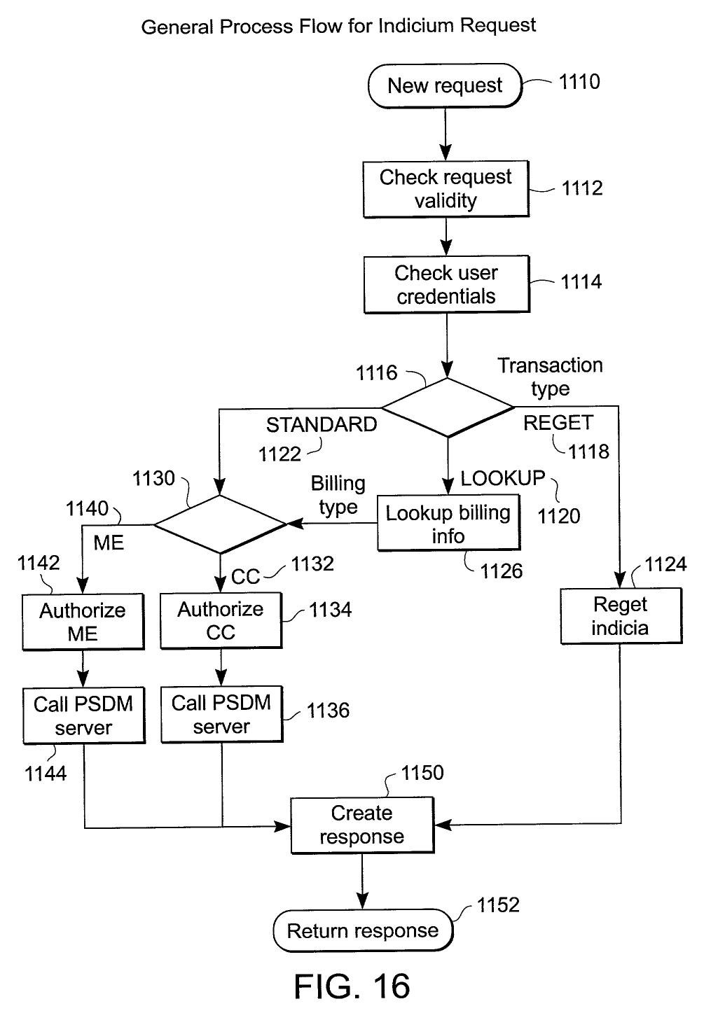

FIG. 16 is a simplified flow chart showing the processing by PVS 102 of an indicium request. PVS 102 gets a XML request from the kiosk at a step 1110. At a step 1112 the XML request is parsed to make sure that it is a well-formed XML document and it is validated against the Request Document Type Definition (DTD) (See Appendix A). At a step 1114 the kiosk's credentials are validated. At step 1116 the transaction type is determined. If the transaction type is a “Reget” transaction 1118, then at step 1124 the indicium or indicia of a previous transaction is returned. Then from step 1124, at step 1150 a response is created and at step 1150 the response is returned to the kiosk. If the transaction type is a “Lookup” transaction 1120, then the billing information is retrieved for a previously generated transaction, and the billing type at step 1130 is determined. If the transaction type is a “Standard” transaction 1122, then at step 1130 the billing type is determined. If the billing type is a credit card (CC) method of payment 1132, then at step 1134 the credit card must be authorized. An error results if the CC is not authorized. At step 1136 the PSDM server 1004 is called, and at step 1150 a response message to the kiosk is created. If the billing type is a bill-to-account or an ME, then at step 1142 the ME must be authorized, otherwise an error occurs. At step 1144 the PSDM server 1004 is called, and at step 1150 a response message to the kiosk is created. The response message typically created at step 1150 is a response XML message including one or more indicia. This response XML message is then sent to the kiosk 104 by the PVS 102. The kiosk 104 uses the Response DTD (see Appendix A) to validate and process this XML response message. One or more indicia are extracted and used to print the stamp(s) on printer 210, for example FIG. 4.

There are several types of XML messages that are passed between the kiosk 104 and the server or PVS 102. First, there must be a request DTD (Document Type Definition) specifying the format and building blocks of the XML request documents from the user or kiosk to the server or PVS. Then there must also be a Response DTD specifying the format of the response from the server or PVS to the user or kiosk. There are three types of XML requests, standard, lookup, and reget, and one type of XML response. Examples of both DTDs, XML requests and XML response are given in Appendix A which is herein incorporated by reference in its entirety. While this XML format is described for use with a PVS and a kiosk, it is not so limited. The DTDs and XML requests and responses may be used in other embodiments with any user, for example other user system 104′ in FIG. 1, connected to a PVS 102, as described in U.S. patent application Ser. No. 09/708,883, entitled “Techniques For Dispensing Postage Using A Communication Network,” which is herein incorporated by reference.

The XML message includes several types: one for a primary request to the PVS, two for secondary requests to the PVS, and one for a response from the PVS. The request transactions are:

<StandardTransaction>—This is a standard indicia request with Credit Card or bill-to account code (ME). This is the primary method of creating indicia.

<LookupTransaction>—This secondary transaction looks for a previously generated transaction and retrieves that transaction's billing information. It then generates more indicia using the same Customer Transaction ID (CTID) as the previous indicia. This is used, for example, when postage is due (e.g. postage was insufficient for package weight and customer is not available to retrieve billing information).

<RegetTransaction>—This secondary transaction gets the indicia or indicium of a previous transaction (specified by CTID or TID). This is useful, for example, if a problem occurred in receiving the original reply. (e.g. paper jam while printing or power loss while receiving transaction).

Responses look the same, however; they are successful or unsuccessful, as specified by:

Success:

<ReturnCode>
<Code>0</Code>
</ReturnCode>
<Indicia> . . . </Indicia>

or
Failure:

<ReturnCode>
<Code>a non-zero value</Code>
</ReturnCode>

The following are annotated examples of the three requests and one response. A typical primary request includes a user's credit card information for payment and request one or more groups of four stamps. Here for illustration purposes only, two stamps are requested. The annotations are in brackets: [ ]

Required preamble for properly formatted XML

<?xml version=“1.0” encoding=“UTF-8” standalone=“no” ?>
<! DOCTYPE request SYSTEM “request.dtd”>
<Request>

<Customer>

<CustomerID>USPS</UserID>
<Password>USPSPassword</Password>

</Customer>
<StandardTransaction>

<BillingTypeCC/> [Other types include : <BillingTypeME/>

which is for billing a pre-established account]

<CTID>38974589739879857589372334</CTID> [User or

kiosk supplies CTID which uniquely identifies this transaction to that user
or kiosk.

kiosk supplies CTID which uniquely identifies this transaction to that user or kiosk. Examples: may be Waybill # or tracking ID up to 36 alphanumeric digits. CTID is unique and fixed for a preset M days, for example 60 days. The CTID may be, for example, 36 characters long. The reason for the unique 60 day CTID is to prevent re-use of a CTID in the event of a lost transaction or to re-bill a customer for additional postage if customer is no longer available. The CTID is incorporated into the indicium as part of the digital signature for validation. Examples of use of the CTID include, invoice number for purchased postage, batch label ID, waybill number for GXG, tracking number on priority mail, or a GUID.]

<CreditCard>

<CleansingLevelLow/>

expectations on how rigidly a credit card is validated. Other options are CleansingLevelMedium and CleansingLevelHigh. Each of these options modifies the behavior of the PVS's rejection or acceptance of a credit card based on a credit-risk rating.]

<CCExpMonth>10</CCExpMonth>
<CCExpYear>2001</CCExpYear>
<CCNumber>411111111111111</CCNumber>
<CCType>Visa</CCType>
<FirstName>Phil</FirstName>
<LastName>Connors</LastName>
<Phone>800.222.3333</Phone> [optional on low]
<Email>none@mail.com</Email> [optional]
<Street>33175 PALMETTO DR <Street> [optional on

low]

<City>UNION CITY</City> [optional on low]
<State>CA</State> [optional on low]
<Zip>94587</Zip> [optional on low]
<Country>USA</Country> [optional on low]

</CreditCard>

<Indicia id=“1”>

<PostageType>GXG</PostageType> [Global eXpress

Guaranteed (GXG). In one embodiment, when this option is selected, the CTID is used as an universal tracking number from origin to destination of the mailpiece. For example, a package may start at location A, where the stamps are affixed. It may then go by a commercial carrier, such as FedEx to location B, then by another commercial carrier, such as DHL to location B, and finally by USPS Express mail to location C. The GXG option uses the CTID as one number to track the package through the various carriers.]

<Amount>0.34</Amount>[Up to 999.999. Up to 3 decimal places (e.g. 0.235 for discounted postage). The entire transaction should add-up to a whole penny amount, otherwise the transaction is rejected. For example, if the customer purchases two 23.5 cent stamps, the PVS will return 2 indicia and bill 47 cents.]

<IBIPData/> [optional, IBIP Data is returned formatted to

the IBIP specification - base64]

<PlainTextData/> [optional, plain text data is the IBIP

information in human-readable format.]

</Indicia>
<Indicia id=“2”>

<PostageType>GXG</PostageType>
<Amount>1.00</Amount>
<Bitmap> [optional, bitmap is a ‘type’ of indicia in a

Datamatrix bitmap format - base64 encoded. <Bitmap> may be replaced
by <FormatRLE/>]

<FormatBMP/>
<Height>200</Height> [Size of bitmap, in

pixels]

<Width>200</Width>

</Bitmap>

</Indicia>

</StandardTransaction>
</Request>

An example of a first secondary request transaction (<LookupTransaction>) requests more indicia from the PVS using billing information from previously created indicia. A Transaction ID (TID) uniquely identifies a single indicium and may be, for example, 26 characters long. The TID or CTID, and stamp amount for a new stamp is sent to the PVS. Then the PVS retrieves previous billing information, generates new stamps, and bills according to the previous billing information. The transaction will be marked with the same CTID as previous transaction. The following is an example of the <LookupTransaction>:

<?xml version=“1.0” encoding=“UTF-8” standalone=“no” ?>
<! DOCTYPE request SYSTEM “request.dtd”>
<Request>

<Customer>

<CustomerID>USPS</UserID>
<Password>USPSPassword</Password>

</Customer>
<LookupTransaction>

<CTID>38974589739879857589372334</CTID>

<Indicia id=“1”>

<PostageType>GXG</PostageType>
<Amount>0.34</Amount>

<IBIPData/>

<PlainTextData/>

</Indicia>
<Indicia id=“2”>

<PostageType>GXG</PostageType>
<Amount>1.00</Amount>
<IBIPData/>
<Bitmap>

<FormatBMP/>
<Height>200</Height>
<Width>200</Width>

</Bitmap>

</Indicia>

</LookupTransaction>

</Request>

An example of a second secondary request transaction (<RegetTransaction>) returns one or more indicia of a previously generated transaction request. This is useful if you lost the transaction due to a power outage or other corruption in the data stream. Either a CTID or TID is used to return the original indicium or indicia. If a TID is passed, only one indicium is returned. If a CTID is passed, all indicia ever generated for that CTID are returned. (i.e. if the original CTID had 10 stamps, all 10 will be returned. If additional indicia are created (via LookupTransaction), those will be returned also). In one embodiment all indicia are returned uniformly. In a <StandardTransaction> request, indicia can have several indicia in different formats. <RegetTransaction> returns all indicia in one format. (e.g. in this example, all indicia are returned with the same <IBIPData> and <Bitmap>). The following is an example of the <RegetTransaction>:

<?xml version=“1.0” encoding=“UTF-8” standalone=“no” ?>
<! DOCTYPE request SYSTEM “request.dtd”>
<Request>

<Customer>

<CustomerID>USPS</UserID>
<Password>USPSPassword</Password>

</Customer>
<RegetTransaction>

<CTID>11143324232423324342234010108</CTID>
<IBIPData/>
<Bitmap>

<FormatRLE/>
<Height>300</Height>
<Width>300</Width>

</Bitmap>

</RegetTransaction>

</Request>

There is one type of <Response> which is an XML response by the PVS to the XML request sent by the user or kiosk. The <ReturnCode> indicates whether indicia or an error code is returned to the customer. The <ReturnCode> includes the following:

| | |
|---|---|
| <Code> | - 0 (zero) - transaction successful. |

- Anything other than zero, see Response Codes section
<Description> Troubleshooting information. Variable format.
<SubCode> Used to pass additional information that may yield / extend

troubleshooting ability in future releases.

The first response example is of a success:
<?xml version=“1.0” encoding=“UTF-8” standalone = “no” ?>
<! DOCTYPE response SYSTEM “Response.dtd”>
<Response>
<ReturnCode>

<Code>0</Code>

</ReturnCode>
<Indicia id = “1”>
<TID>123843843897847897348773</TID>
<IBIPData>

VOvwP+jz0D/y/wQG2urxewweweIOzWUAaBdddfsdfABVGuvw//sdfffLwLOvwHOr</IBI
PData>

<PlainTextData>
<VersionNo>12</VersionNo>
<AlgorithmID>2</AlgorithmID>
<CertificateSerialNo>2321</CertificateSerialNo>
<ManufacturerID>23</ManufacturerID>
<ModelID>778</ModelID>
<SerialNo>5676576</SerialNo>
<AscendingRegister>6577</AscendingRegister>
<Postage>65567</Postage>
<Date>10.10.2001</Date>
<DescendingRegister>657677656</DescendingRegister>
<RateCategory>4543544543</RateCategory>
<DigitalSignature>4434534567567688086777876096577099</DigitalSignatu

re>

</PlainTextData>
</Indicia>
<Indicia id=“2”>
<TID>123843843897847897348774</TID>[The Transaction ID (TID) is

<TID>123843843897847897348774</TID>[The Transaction ID (TID) is returned as part of a response within the <indicia>. TID uniquely identifies a single indicium and is typically received by the PVS as part of a Reget or Lookup request. When used in REGET and LOOKUP transactions, the TID originally assigned by the PVS is used by the PVS to re-retrieve or bill that transaction.]

<BitmapData>

VOvwP+jz0D/y/wQG2urxIOjzWUAaBgAAGQEtADEPAABVGuvw//LwLO

vwHOjzoPr0Bw/r8Pbx6vFK5/QEOuvwROvwAQBUMQHo84Dy8UUPVw/y8eD7LQHq8W
jq5/QP6/BU6/ACAFSFGOvwPN/8jAGMAeb1Aa6RAgAAAyoEBevwBqrr8Afr8Ajr8Anr8A
qq6/AL6/AM6/AN6/AO6uvwk+P4L8ACVQEB+QG6Ad8BAgBiAQDV/g0SARMWAhMW
A2JPAAD+hbgE6vGJABP/MHoUrkfheoSlP7YDQOb1vwECOBMQQJECSBYWFTIQIRdr
EgNXFq4WEwRiAhUUBYEWBiqBFgeBFgilEYa8BOrxAVUAFLIK7BgNHoIaKxefFCQU
Fa4Sh8AE6v

</BitmapData>
</Indicia>
</Response>
The second example is of a failure:
<?xml version=“1.0” encoding=“UTF-8” standalone=“no” ?>
<! DOCTYPE response SYSTEM “Response.dtd”>
<Response>
<ReturnCode>

<Code>0310</Code>

<Description>Payment failure: CC failure</Description>

<SubCode>Decline due to incorrect CVVrequest_id =

| 979879879878 | </SubCode> |
|---|---|
| | </ReturnCode> |
| | </Response> |

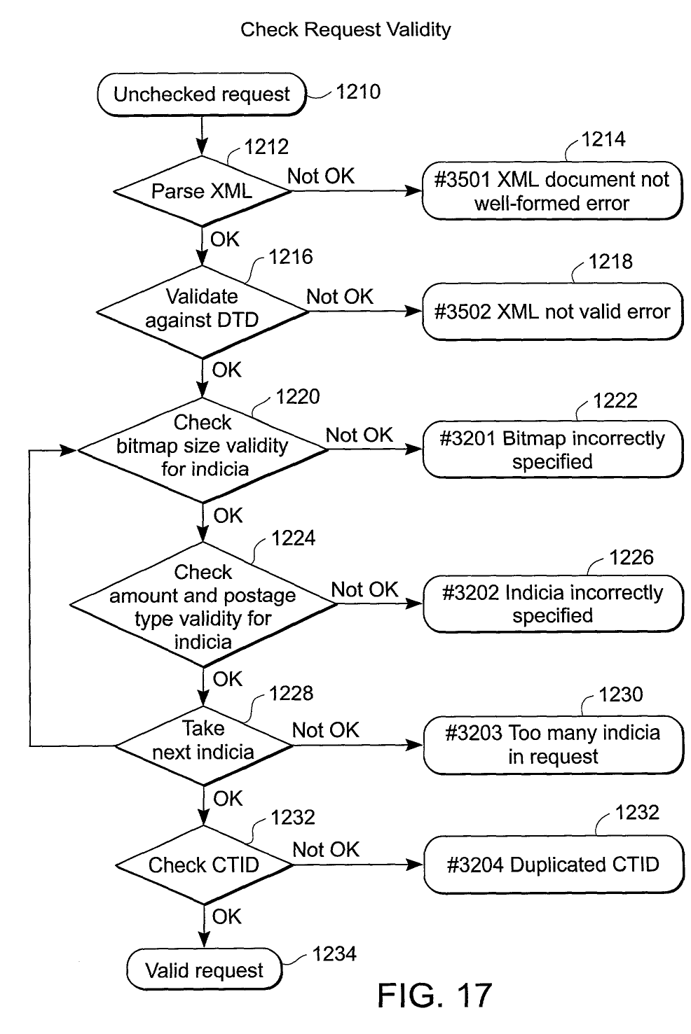

FIG. 17 is a flowchart expanding on the check request validity (step 1112) of FIG. 16 of an embodiment of the present invention. At a step 1212 the XML request received from the user system is parsed to check if it is a well formed XML document. At a step 1216 the parsed XML document is validated against the request DTD. The bitmap is then checked to determine if it is correctly specified (step 1220). At step 1224 the postage type and amount is checked. At a step 1228 the number of indicia is checked. At a step 1232 the CTID is checked for a duplicate CTID within the 60-day window.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware or only in software or using combinations thereof. For example, while the preferred implementation of the kiosk uses a touch screen for input, a separate keypad along the lines of ATMs could be used.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for obtaining a postage stamp at a kiosk, comprising a computer system and a printer, said method comprising:
inputting by a user into said kiosk a request for said postage stamp;
sending said request to a server via a communications network;
receiving from said server a markup language response;
processing said markup language response to obtain an indicium, said indicium comprising a digital signature; and
printing said indicium by said printer on a label to obtain said postage stamp.

2. The method of claim 1 wherein said markup language response comprises a logical structure having customizable constraints.

3. The method of claim 2 wherein said customizable constraints include a Document Type Declaration (DTD).

4. The method of claim 1 further comprising validating said markup language request using a response markup language declaration.

5. The method of claim 4 wherein said markup language response declaration is an element type declaration in a Document Type Declaration (DTD).

6. The method of claim 1 wherein said markup language response is an extensible markup language (XML) response.

7. The method of claim 1 wherein said markup language response comprises a statement of a markup language selected from a group consisting of HTML, XML, or SGML.

8. The method of claim 1 wherein said markup language response is a Standard Generalized Markup Language (SGML) response.

9. The method of claim 1 wherein said markup language response includes a transaction identifier (TID).

10. The method of claim 1 wherein when said printer is printing said indicium on a label, displaying a moving image on a display.

11. The method of claim 1 wherein when said printer is printing said indicium on said label, displaying an image on a display.

12. A method for obtaining a postage stamp at a kiosk, comprising a computer system and a printer, said method comprising:
inputting by a user into said kiosk a request for said postage stamp and payment information;
sending said request and said payment information to a server via a communications network;
receiving from said server an XML response;
processing said XML response to obtain an indicium, said indicium comprising a digital signature; and
printing said indicium by said printer on a label to obtain said postage stamp, said label comprising one or more security features.

13. The method of claim 12 further comprising:
said server receiving a XML request comprising said request and said payment information;
processing said XML request to obtain said request and said payment information;
validating said payment information; and
responsive to said validating, generating said indicium based on said request.

14. The method of claim 13 wherein said XML request further includes a GXG postage type.

15. The method of claim 13 wherein said XML request further includes a customer transaction identifier (CTID).

16. An electronic kiosk for a user obtaining a postage stamp from a central server via a communications network, said electronic kiosk comprising:
a processor operating on software stored in a memory, said software comprising a markup language processor for reading a markup language document comprising an indicium;
a housing having said display, said processor, and said memory;
network interface circuitry (NIC) connecting said processor to said communications network, said NIC for receiving said markup language document; and
a printer coupled to said memory for printing said stamp using said indicium.

17. The electronic kiosk of claim 16 wherein said markup language document is an XML document.

18. The electronic kiosk of claim 16 further comprising a display showing a browser window for postage stamps.

19. The electronic kiosk of claim 16 wherein said software further comprises a browser module and an ID module that validates a first kiosk ID at the kiosk with a second kiosk ID at said central server.

20. The electronic kiosk of claim 19 wherein said first kiosk ID is stored in a window's registry.

21. The electronic kiosk of claim 19 wherein said first kiosk ID is a MAC address of said NIC.

22. A method for obtaining a postage stamp at a kiosk, comprising a processor, a magnetic card reader, a touch screen display, and a printer, said method comprising:
receiving a request for said postage stamp via said touch screen display;
receiving payment information from said magnetic card reader;
forming an XML request comprising said request and said payment information
sending said XML request to a server via a communications network;
said server validating said XML request using a request DTD;
processing said XML request to obtain said request and said payment information;
validating said payment information;
responsive to said validating, generating an indicium based on said request;
said indicium including a digital signature;
forming an XML response comprising said indicium;
receiving from said server said XML response;
validating said XML response using a response DTD;
processing said XML response to obtain said indicium; and
printing said indicium by said printer on a label, said label comprising security features.

23. The method of claim 22 wherein when said printer is printing said indicium on said label, displaying a portion of a video clip on said touch screen display.

24. The method of claim 22 wherein when said printer is printing said indicium on said label, displaying an image on said touch screen display.

25. A method of obtaining a postage stamp from a kiosk, said kiosk comprising a processor and a printer, said method comprising:
obtaining a sequence of characters upon paying for said postage stamp at a cash register;
inputting said sequence of characters into said kiosk;
sending a XML request for said postage stamp to a server;
receiving a XML response comprising an indicium; and
printing said indicium, by said printer on a pre-processed label to obtain said postage stamp.

26. The method of claim 18 wherein said pre-processed label includes one or more security features.

27. A computer program product stored in a computer readable medium for obtaining a postage stamp at a kiosk, said kiosk, comprising a computer system and a printer, said computer program product comprising:
code for receiving a request for said postage stamp;
code for sending said request to a server via a communications network;
code for receiving from said server a markup language response;
code for processing said markup language response using a markup language response declaration to obtain an indicium representing said postage stamp, said indicium comprising a digital signature; and
code for printing said indicium by said printer on a label.

28. The method of claim 27 wherein said markup language response is an extensible markup language (XML) response.
